(19) United States
(12) Patent Application Publication
(10) Pub. No.: US 2006/0109591 A1
(43) Pub. Date: May 25, 2006

(54) Method of making substrates for media used in hard drives

(76) Inventors: Rajiv Yadav Ranjan, San Jose, CA (US); Shashi Bhusan Agarwal, Santa Clara, CA (US); Ian Joseph Beresford, Milpitas, CA (US); Koji Shima, Saratoga, CA (US); Keith Goodson, San Jose, CA (US); Joel Richard Weiss, Fremont, CA (US)

Correspondence Address: SEAGATE TECHNOLOGY LLC;INTELLECTUAL PROPERTY DEPARTMENT, 920 DISC DRIVE, MS/SV15B1, SCOTTS VALLEY, CA, 95066-4544, US

(21) Appl. No.: 10/993,739

(22) Filed: Nov. 19, 2004

(51) Int. Cl. G11B 5/82

(52) U.S. Cl. 360/135

(57) ABSTRACT

A method for making substrates is disclosed. The method comprises providing a rod, which is made out of a substrate material and has an outside diameter substantially the same size as the outside diameter of a finished substrate and an inside diameter substantially the same size as the inside diameter of the finished substrate. The rod is cut with a multi-wire cutter to make a substrate slice substantially the same size as a finished substrate. The multi-wire cutter has wires positioned to substantially match the final thickness of the finished substrate. Additionally the cutting process is facilitated by using slurry and by providing a rocking motion between the rod and the wires of the multi-wire cutter so that the wires contact the rod in a rocking motion with respect to a normal to the center of the rod.

### BACKGROUND OF THE INVENTION

1. Field of the Invention

The present invention relates generally to substrates, and more particularly to a method for making substrates used for magnetic recording media in hard drives.

2. Description of the Related Art

Conventional hard drives are used to magnetically record, store and retrieve digital data. Data is recorded to and retrieved from one or more magnetic recording media that are rotated at three thousand six hundred revolutions per minute (rpm) or more by a motor. The data is recorded and retrieved from the magnetic recording media by an array of vertically aligned read/write head assemblies, which are controllably moved from data track to data track by an actuator assembly.

The three major components making up a conventional hard drive are magnetic recording media, read/write head assemblies and motors. Magnetic recording media, which is used as a media to magnetically store digital data, typically includes a layered structure, of which at least one of the layers is made of a magnetic material, such as CoCrPtB, having high coercivity and high remnant moment. The read/write head assemblies typically include a read sensor and a writing coil carried on an air bearing slider attached to an actuator. This slider acts in a cooperative hydrodynamic relationship with a thin layer of air dragged along by the spinning magnetic recording media to fly the head assembly in a closely spaced relationship to the magnetic recording media surface. The actuator is used to move the heads from track to track and is of the type usually referred to as a rotary voice coil actuator. A typical rotary voice coil actuator consists of a pivot shaft fixedly attached to the hard drive housing closely adjacent to the outer diameter of the magnetic recording media. Motors, which are used to spin the magnetic recording media at rates of three thousand six hundred revolutions per minute (rpm) or more typically include brushless direct current (DC) motors. The general structure of hard drives is well known.

Magnetic recording media can be locally magnetized by a read/write head, which creates a highly concentrated magnetic field that alternates direction based upon bits of the information being stored. The highly concentrated localized magnetic field produced by the read/write head magnetizes the grains of the magnetic recording media at that location, provided the magnetic field is greater than the coercivity of the magnetic recording media. The grains retain a remnant magnetization after the magnetic field is removed, which points in the same direction of the magnetic field. A read/write head that produces an electrical response to a magnetic signal can then read the magnetization of the magnetic recording media.

Magnetic recording media structures are typically made to include a series of thin films deposited on top of a substrate. The substrate may be made of aluminum, ceramic, or glass material. The magnetic recording media thin film structure typically includes a nickel-phosphorous (NiP) layer, a seed layer, a magnetic layer, and a protective layer 130 deposited on a substrate. The substrate can be made of aluminum, glass, ceramic or other material.

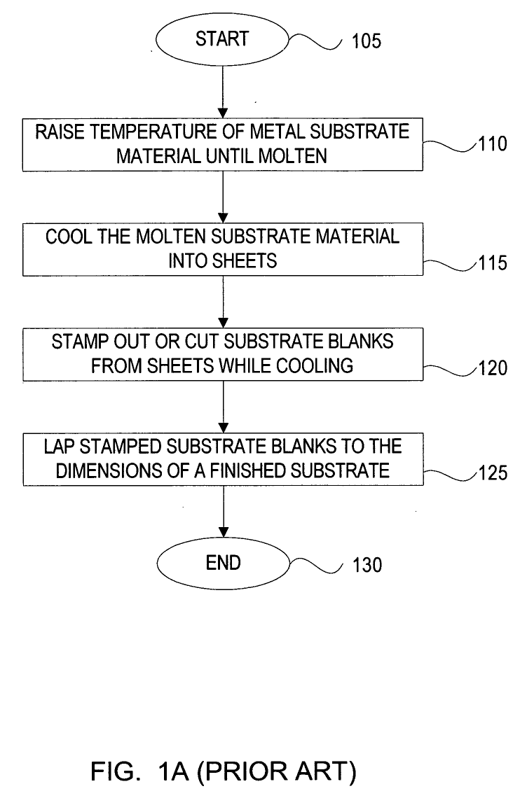

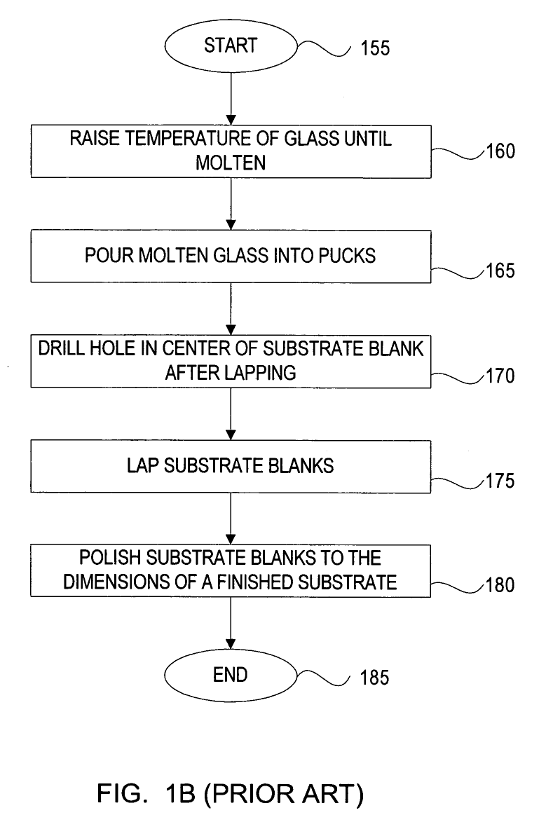

FIG. 1A is a flowchart illustrating the prior art method of making metal substrates used for magnetic recording media. The process begins in step 105 where the substrate material is selected. In this case the substrate material is metal and more specifically aluminum. Next in step 110 the temperature of the substrate material is raised until the material becomes molten. In step 115 the substrate material is poured into sheets and cooled to form sheets of the molten material. In step 120 unfinished substrates are either stamped out or cut out while the sheets are cooling. In step 125, after the unfinished substrates have cooled down the unfinished substrates are lapped down to the final thickness dimensions of a finished substrate. The lapping process is done using conventional lapping and machining tools. Finally in step 130 the finished metal substrates are used to make magnetic recording media used in hard drives.

FIG. 1B is a flowchart illustrating the prior art method of making glass substrates used for magnetic recording media. The process begins in step 155 where the substrate material is selected. In this case the substrate material is glass. Next in step 160 the temperature of the glass substrate material is raised until the glass material becomes molten. In step 165 the molten glass substrate material is poured into pucks and cooled to form unfinished substrates of approximately the shape of finished substrates. In step 170 a hole is drilled through the center of the unfinished substrates after the molten glass substrate material is allowed to cool and solidify. In step 175, the unfinished substrates are lapped down to dimensions, which are close to the finished substrate dimensions. Typically, the pucks made in step 165 are about 1-2 mm thick, and the lapping process of step 175 includes lapping the puck down to 650 microns with a first lapping process and then further lapping the puck down to about 400 microns with a second lapping process. In step 180 the unfinished substrates are polished to the precise dimensions of the finished substrate. The lapping and polishing processes of steps 175 and 180 respectfully are done using conventional lapping, polishing and machining tools. Finally in step 185 the finished glass substrates are used to make magnetic recording media used in hard drives.

Although the method for making substrates described above, with reference to FIGS. 1A and 1B, are commonly used to produce high quality substrates, both methods are complex and costly. Additionally the methods described above require furnaces, stampers and other associated equipment for making either glass or metal substrates, which is costly, takes considerable amount of space and is expensive to operate. The result of using these complex and costly methods is an expensive finished substrate.

Therefore what is needed is a method that overcomes these problems and makes it possible to produce an inexpensive high quality substrate for the magnetic recording media. Additionally, a method that permits the manufacture of high quality inexpensive metallic and non-metallic substrates such as glass is needed.

### SUMMARY OF THE INVENTION

One embodiment of the invention teaches a process for making substrates, which is simpler and cheaper than conventional methods. One specific application for the substrates made in accordance with this embodiment is to make magnetic recording media used in hard drives to record information.

One embodiment of the invention that reduces the cost associated with making substrates includes using a cutter with cutting elements to cut rods into substrates. The cutter can be a multi-wire cutter, laser, high pressure impingement cutter, high pressure water jet cutter, multi-band saw, and multi-blade saw and the cutting elements can include wires, blades, bands, water, impinging material, laser energy, radiation energy, etc. This embodiment for making substrates comprises providing a rod made out of a substrate material, wherein the rod has an outside diameter substantially the same size as the outside diameter of a finished substrate. The substrate material can be glass, ceramic, silicon, sapphire, plastic, or metal. The rod is cut with a multi-wire cutter to make a substrate slice substantially the same size as a finished substrate. The cutter has cutting elements positioned to substantially match the final thickness of the finished substrate. Additionally the cutting process is facilitated by using slurry and by providing a rocking motion between the rod and the wires of the multi-wire cutter so that the wires contact the rod in a rocking motion with respect to a normal to the center of the rod.

Another embodiment for making substrates comprises using a multi-wire cutter to cut rods into substrates, providing a rod made out of a substrate material, wherein the rod has an outside diameter substantially the same size as the outside diameter of a finished substrate and an inside diameter substantially the same size as the inside diameter of the finished substrate. The substrate material can be glass, ceramic, silicon, sapphire, plastic, or metal. The rod is cut with a multi-wire cutter to make a substrate slice substantially the same size as a finished substrate. The mutli-wire cutter has wires positioned to substantially match the final thickness of the finished substrate. Additionally the cutting process is facilitated by using slurry and by providing a rocking motion between the rod and the wires of the multi-wire cutter so that the wires contact the rod in a rocking motion with respect to a normal to the center of the rod.

Another embodiment for making substrates comprises providing a rod made out of a substrate material, wherein the rod has an outside diameter substantially the same size as the outside diameter of the finished substrate, drilling a hole in the center of the rod, wherein the hole has a diameter that is substantially similar to an inner diameter of a finished substrate, cutting the rod with a multi-wire cutter to make substrate slices substantially the same size as a finished substrate. The mutli-wire cutter has wires positioned to substantially match the final thickness of the finished substrate. The cutting process uses slurry to facilitate cutting and the wires of the multi-wire cutter can contact the rod in rocking motion with respect to a normal to the center of the rod. Additionally, the process comprises grinding the inside diameter and outside diameter edges of the substrate slice to obtain a substrate blank having dimensions closer to the finished substrates, and polishing the inside diameter and outside diameter edges of the substrate blank to obtain dimension of the finished substrates.

Another embodiment for making substrates comprises providing a rod made out of a substrate material, wherein the rod has an outside diameter substantially the same size as the outside diameter of the finished substrate, making grooves on an outside surface of the rod, drilling a hole in the center of the rod, wherein the hole has a diameter that is substantially similar to an inner diameter of a finished substrate, cutting the rod with a multi-wire cutter to make substrate slices substantially the same size as finished substrates. The multi-wire cutter has wires positioned to substantially match the final thickness of the finished glass substrate. The cutting process uses slurry to facilitate cutting and the wires of the multi-wire cutter contact the rod in rocking motion with respect to a normal to the center of the rod. Additionally, the process comprises grinding the inside diameter and outside diameter edges of the substrate slice to obtain a substrate blank having dimensions closer to the finished substrates, and polishing the inside diameter and outside diameter edges of the substrate blank to obtain dimension of the finished substrates.

Another embodiment comprises surface treatment of the rods by exposing the outside surface and the inside surface of the rods to chemical solutions containing K and Li to enrich the surface substantially with these elements and thereby resulting in substantially compressive stress at the surface. Surface treatment, which enables the exposed surface of the cut pieces to be less prone to crack-initiation, includes chemical strengthening, thermal tempering, and applying a hardening overcoat, adhesive, or laminate layer.

The present invention also can be implemented as a computer-readable program storage device that tangibly embodies a program of instructions executable by a computer system to perform a system method. In addition, the invention also can be implemented as a system itself.

These and various other features as well as advantages which characterize the present invention will be apparent upon reading of the following detailed description and review of the associated drawings.

### BRIEF DESCRIPTION OF THE INVENTION

FIG. 1A is a flowchart illustrating the prior art method of making metal substrates used for magnetic recording media;

FIG. 1B is a flowchart illustrating the prior art method of making glass substrates used for magnetic recording media;

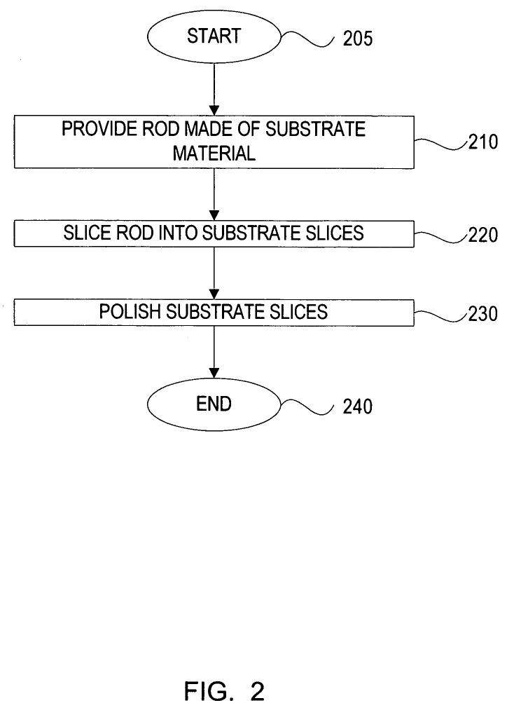

FIG. 2 is a flowchart showing the preferred method of making substrates, which are used for magnetic recording media, out of a rod in accordance with an embodiment of the invention;

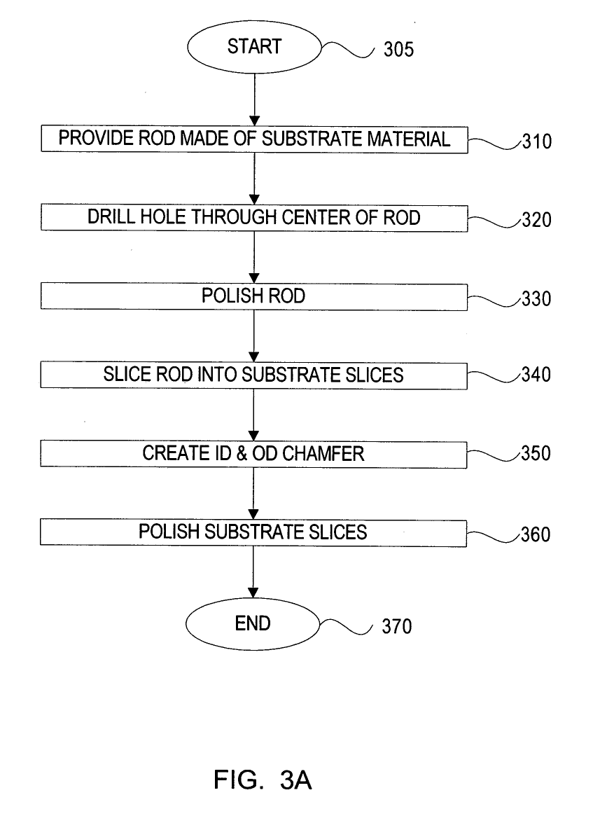

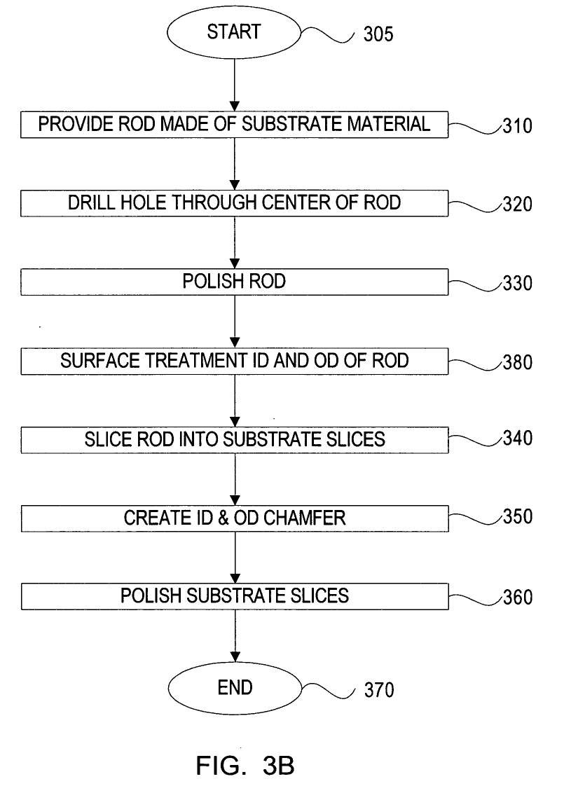

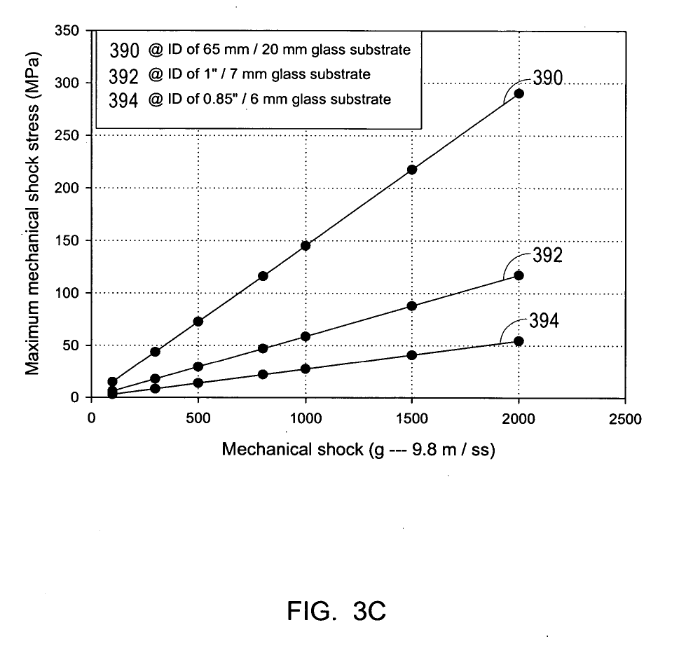

FIG. 3A is a flowchart showing a method of making substrates, which are used for magnetic recording media, out of rod with a hole in accordance with another embodiment of the invention;

FIG. 3B is a flowchart showing another embodiment of a method of making substrates, which are used for magnetic recording media, out of a surface treated rod in accordance with another embodiment of the invention;

FIG. 3C is a graph showing Shock vs. Stress by form factor for glass substrates with varying outside diameter (OD) and inside diameter (ID);

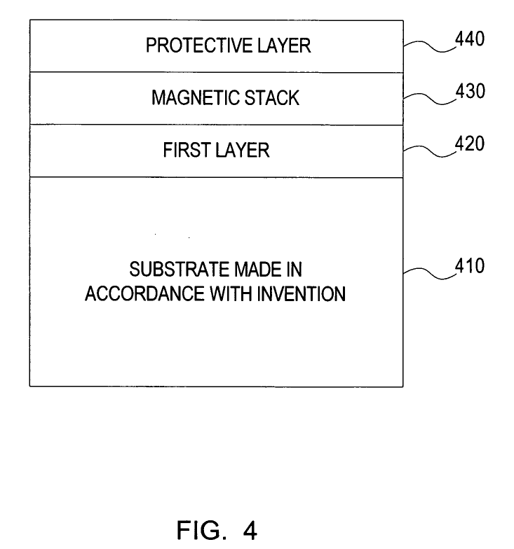

FIG. 4 is a block diagram showing a magnetic recording media using a substrate made with the method described with reference to FIG. 2;

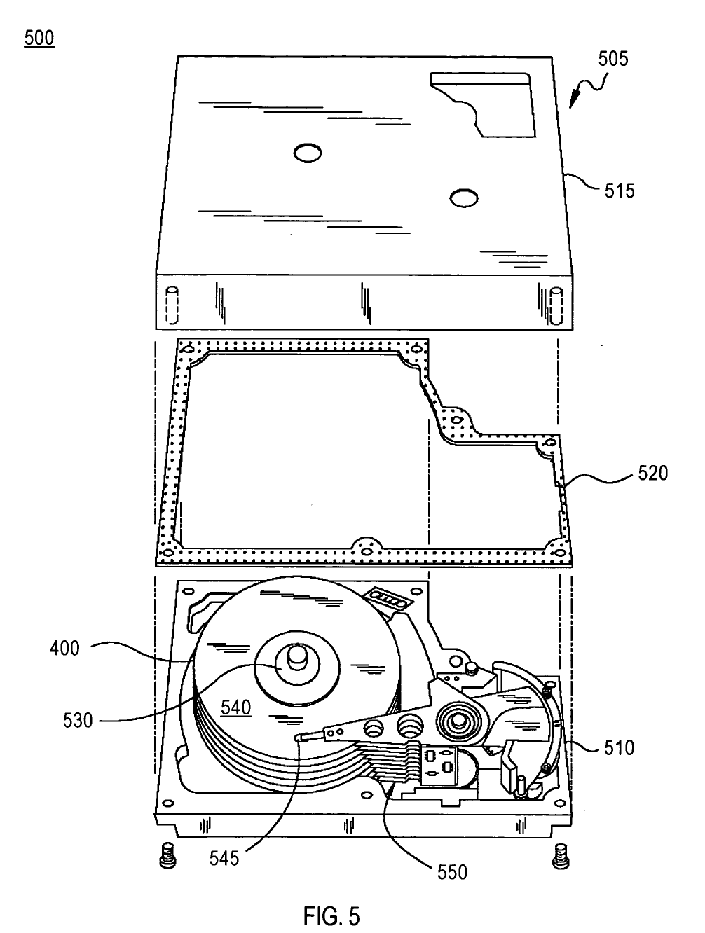

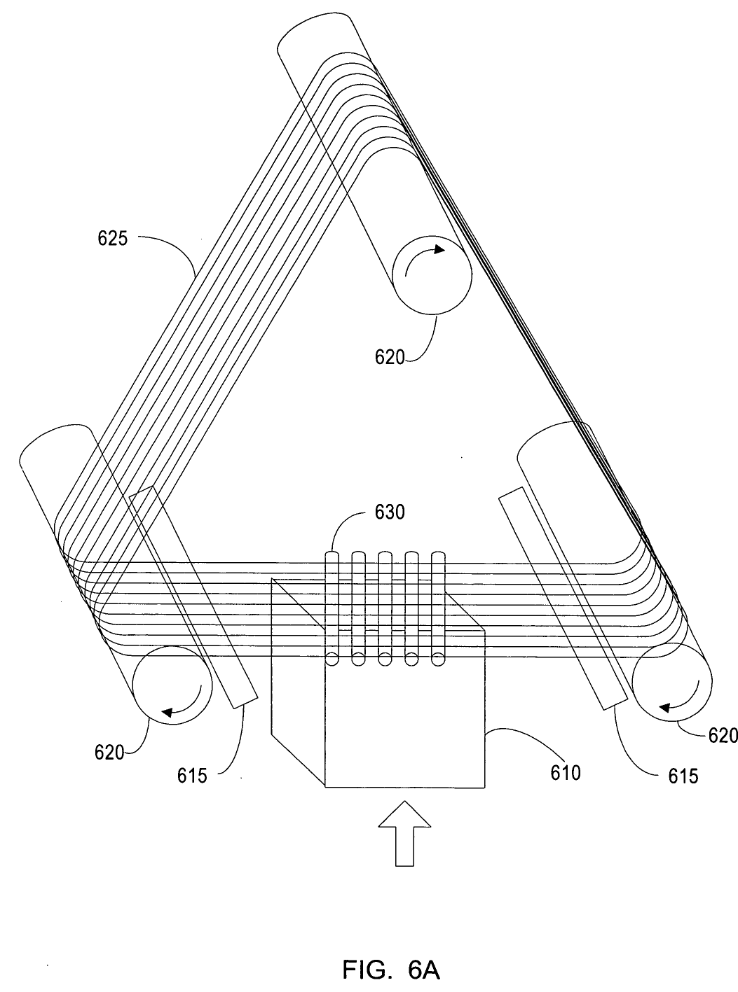

FIG. 5 is a block diagram showing a hard drive using the magnetic recording media described with reference to FIG. 4

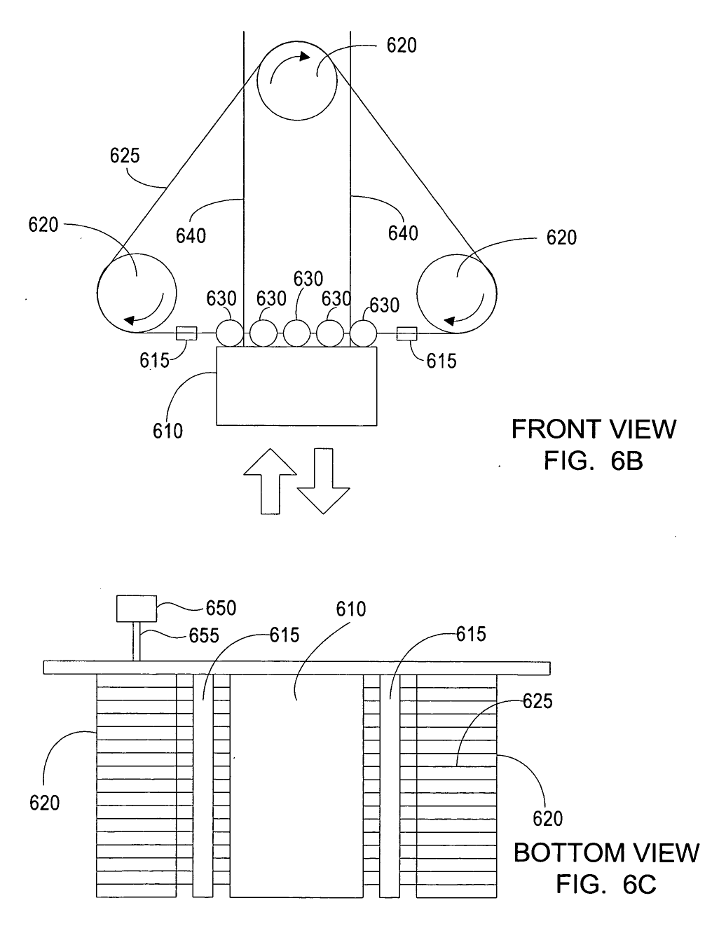

FIG. 6A is an illustration showing a multi-wire cutter used for cutting rods to make substrates for magnetic recording media in accordance with one embodiment of the invention;

FIG. 6B is a front view of the multi-wire cutter shown in FIG. 6A;

FIG. 6C is a bottom view of the multi-wire cutter shown in FIG. 6A;

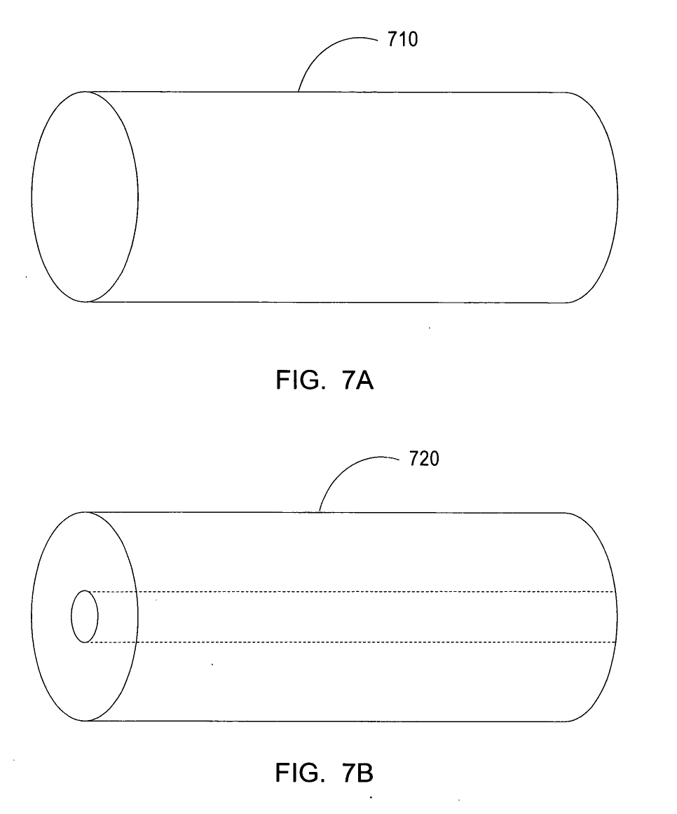

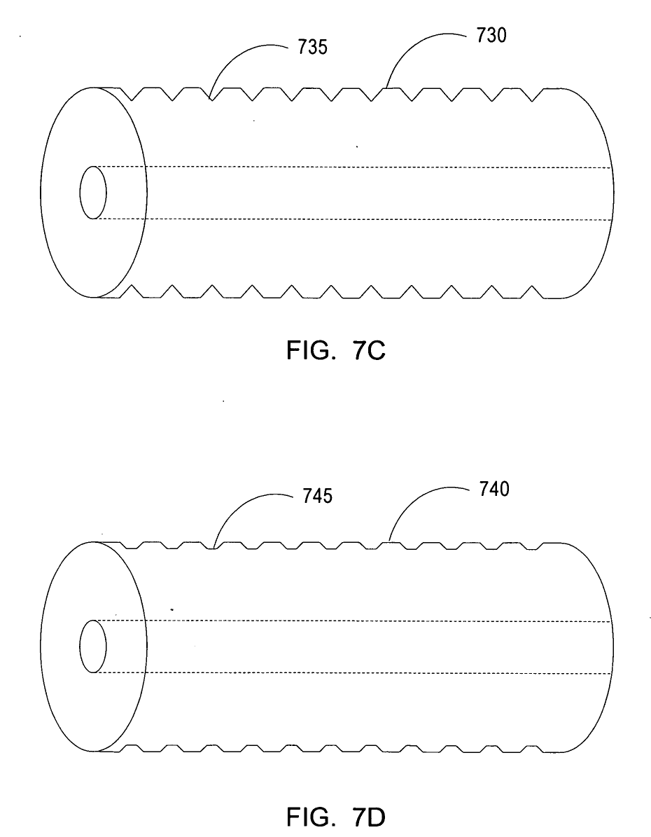

FIG. 7A is an illustration showing a rod used to make substrates for magnetic recording media in accordance with one embodiment of the invention;

FIG. 7B is an illustration showing a rod with a hole drilled in the center used to make substrates for magnetic recording media in accordance with one embodiment of the invention;

FIG. 7C is an illustration showing a rod with v-shaped grooves used to make substrates having a edge chamfer for magnetic recording media in accordance with one embodiment of the invention; and

FIG. 7D is an illustration showing a rod with long half hexagon grooves used to make substrates having a edge chamfer for magnetic recording media in accordance with one embodiment of the invention.

### DETAILED DESCRIPTION OF THE PREFERRED EMBODIMENTS

The invention provides a method for making substrates used for magnetic recording media, which is applicable to both metallic substrates such as aluminum and non-metallic substrates such as glass, ceramic, borosilicate, alumina silicate, silicon, sapphire, plastic. Additionally this invention provides for a new magnetic recording media and hard drive, which uses the substrate made with the inventive process.

FIG. 2 is a flowchart showing the preferred method of making substrates used for magnetic recording media in accordance with an embodiment of the invention. Magnetic recording media is typically used in a hard drive to record and retrieve information and is made of a substrate and one or more magnetic layers as is further described with reference to FIG. 4 and FIG. 5 below.

The process of making the substrate used for magnetic recording media begins in step 205 where the substrate material is selected. The substrate material can be glass, ceramic, borosilicate, alumina silicate, silicon, sapphire, plastic, or metal. Next in step 210 a rod made of the substrate material is provided. The shape of the rod is preferably cylindrical but can be other shapes as described in more detail with reference to FIGS. 7A-7D below. The term rod should be interpreted in the broadest sense to include cylindrically shaped objects as well as other objects and can be loosely defined as the space bounded by a cylinder or other geometric object and two parallel planes with no limitations on its length. If the hard drive design uses magnetic recording media that is mounted to a motor and shaft through a hole in the center of the media then the substrate used to make the magnetic recording media should also have a hole in the center and in such a case a rod with a hole pre-drilled through its' center as shown in FIG. 7B is preferable. Additionally, the rod should have an outside diameter substantially the same size as the outside diameter of the finished substrate and an inside diameter that is substantially similar to an inner diameter of a finished substrate. However if a hard drive design is used which does not include a hole in the center of the magnetic recording media then a rod without a hole in the center as shown in FIG. 7A is preferably used. Details of a hard drive using magnetic recording media without a hole in the center are further discussed with reference to FIG. 5 below.

A finished substrate is defined to be a substrate that is substantially the same size as a substrate that is ready to have layers deposited on it and made into a magnetic recording media as is further discussed with reference to FIG. 4 below. A substrate slice is defined as the product resulting from slicing a rod in accordance with this invention. A substrate blank is defined as a substrate that has not been finished and therefore requires more processing before it becomes a finished substrate. A desired dimension such as a desired thickness, desired inner diameter, desired outer diameter, desired final diameter, etc can be the precise final value of the desired dimension or can be an intermediate value that is only desired for some specific step but can change with further processing.

Next in step 220 the rods are sliced into substrate slices using a multi-wire cutter. Although this invention is described using a multi-wire cutter to slice the rod, the slicing can be done with a different cutter having different cutting elements. For example, a cutter can include a laser, high pressure impingement apparatus such as with high-pressure water cutter, high pressure water jet cutter, multi-band saw, multi-blade saw, etc, and cutting elements can include wires, blades, bands, water, impinging material, laser energy, radiation energy, etc. The spacing between the cutting elements should be adjustable to accommodate variable desired thickness. In one embodiment of the invention a multi-wire cutter is used to cut the rod with a hole in the center. When using a multi-wire cutter, these rods are loaded into a multi-wire cutter like the one shown in FIG. 6. The spacing between the wires is precisely adjusted to match the desired thickness of the substrate slice. Desired thickness can be the precise final thickness of a substrate or can be an intermediate thickness of the substrate blank suitable for additional process steps such as lapping or polishing. The substrate slices can be cut to any desired thickness but are preferably cut to a thickness close to the thickness of the finished substrate, which can range from 250 microns to 1.2 mm. If subsequent processing after slicing in step 220 only includes further polishing or grinding, then the substrate slice is cut so that its thickness is close but thicker than the thickness of the finished substrate. However, if subsequent processing after slicing in step 220 includes steps that could increase the thickness such as plating then the substrate slices could be either thicker or thinner than the finished substrates depending on the requirements for the properties of the finished substrate.

For example, in one embodiment where subsequent processing after slicing in step 220 can only include further polishing then the substrate slice can be cut to be approximately 45 microns thicker than the finished substrate so that if the final thickness of the finished substrate is 380 microns then the substrate slice may be cut to approximately 425 microns. In another embodiment where subsequent processing after slicing in step 220 includes plating or other processing that adds material to the finished substrate then the substrate slice can be cut to be approximately 50 microns thinner than the finished substrate because subsequent processing will add the remaining 50-micron thickness. By cutting the substrate slice close to the final thickness of the finished substrate, any subsequent steps of polishing or grinding can be minimized or even eliminated, as is further discussed below. Table 1 illustrates some preferred examples of substrate slice thickness for different finished substrates resulting from a process that only includes further processing steps of polishing or grinding the substrate slice. Although the preferred method data in Table 1 illustrates that the Substrate Slice thickness=Finished Substrate Thickness+(45±10 microns), the difference between the substrate slice thickness and finished substrate can vary depending on the process.

TABLE 1
Examples of Substrate Slice Thickness vs. Finished Substrate Thickness

| Finished Substrate Thickness | Substrate Slice Thickness |
|---|---|
| 381 microns (15 mils) | 425 ± 10 microns |
| 635 microns (25 mils) | 680 ± 10 microns |
| 800 microns (40 mils) | 845 ± 10 microns |
| 1200 microns (50 mils) | 1245 ± 10 microns |

The multi-wire cutters usually require slurry, which is fed in front of the wire before it starts the cutting action. Slurry can include a suspension of particulate material or coolant material with or without particulates. The role of slurry and coolant is to facilitate the cutting process and making smoother finished surfaces. The choice and chemistry of the slurry is chosen based on the starting material of the rod and the preferred cut rate. One example of a slurry is an aqueous mixture of colloidal SiO₂ particles, which are smaller than 1 micron, and make up less than 20% of the slurry by volume. Alternatively, a diamond or particulate impregnated wire can be used which may not require slurry. The wires can contact the rod surface in a rocking motion with respect to a normal to the center of the rod. This process is helpful for maintaining a uniform load on the entire cutting surface resulting in a much smoother starting surface and thereby either minimizing the final-grind time or completely eliminating the final-grind process discussed in step 230.

In step 230 the substrate slices are polished to the precise dimensions and preferred surface quality of the finished substrate. This step may be minimized or eliminated altogether if care is taken to select the optimum cutting conditions and slurry used in the cutting process of step 220. Finally in step 240 the finished substrates are used to make magnetic recording media used in hard drives as is further described with reference to FIGS. 4 and 5, below.

FIG. 3A is a flowchart showing another method of making substrates used for magnetic recording media in accordance with another embodiment of the invention. The process of making the substrate used for magnetic recording media begins in step 305 where the substrate material is selected. In step 310, a rod made out of a starting material is provided. Preferably the rod has an outside diameter, which is approximately similar in size to the finished substrate or only slightly larger so that it can easily be polished or ground to the final dimensions of the finished substrate. Additionally and preferably the rod is made out of starting material that is substantially the same as that of the finished substrate and contains a hole in the center, substantially close to the dimension of the finished substrate. In one embodiment the starting material and the finished substrate material can be glass, ceramic, borosilicate, alumina silicate, silicon, sapphire, plastic, or metal. If the starting material is glass, then the glass rod can be molded or drawn to that dimension. If the rod provided in step 310 does not have a hole in the center, then in step 320 a hole is drilled through the center of the rod so that the inside diameter of the rod is substantially the same size as the inside diameter of the finished substrate. Alternatively the diameter of the hole in the rod can be made slightly smaller so that it can easily be polished or ground to the desired dimension of the finished substrate. The hole is drilled with drilling processes known in the art and adapted for the starting material of the rod. For example, if the starting material is glass then the appropriate drill, cutting tool as well as speeds can be adjusted. Drilling should be interpreted in the broadest sense to include drilling with a drill, coring bit, boring tool, honing tool, ultrasonic drilling apparatus, sonic drilling apparatus, as well other methods known in the art. An advantage of starting with a thick-walled tube without a hole in the center is to eliminate any micro-cracks at the inner diameter (ID) area as well as at the outer diameter (OD) area.

The term grind, ground or grinding are used to mean the process of changing the dimensions of a material whether it be by the plain meaning of the word grinding which includes using a grinding wheel to change the dimension of an object or using another techniques such as laser cutting, wire cutting, turning on a lathe, etc.

The starting material of the rod can be glass, ceramic, silicon, sapphire, plastic, chemically treated glass, or metal such as, Aluminum, steel, Ti, etc. The glass material can be amorphous or crystalline. One of the preferred materials for amorphous glass can be boro-silicate type glass with essentially no Na or K ions.

Next in step 330 the rod undergoes a first polishing process where the rod is polished down or ground to the final dimensions of the finished substrates so that the inside of the rod is the dimension of the finished substrate inside diameter (ID) and the outside of the rod is the dimension of the finished substrate outside diameter (OD). Polishing or grinding can be done with polishing or grinding methods known in the art and can include polishing the ID and OD surface of the rod with a hole using a grind stone, polishing tape or isolated grind particles in a slurry. This step can be optimized according to the material of the rod that is used. Polishing step 330 can be done in a single polishing step or in mutliple polishing steps depending on the amount of material which must be removed. Preferably this process is done in two steps consisting of a primary and secondary polishing process, where both the inside surface and outside surface of the rod are polished. The primary and secondary polishing processes can be done is separate polishing apparatuses or can be done in a single polishing apparatus that has been modified to accommodate both the primary and secondary polishing processes. The primary process is a rough removal process and the secondary process is a fine removal process. The primary polishing processes uses high density, formable polishing pads made of a polyurethane or woven material with an amorphous glass material deposited on the polishing surfaces that is derived from metal silicate, and a slurry having particles of CeO₂, which are smaller than 2.0 μm, and make up 1-10% of the slurry by volume. The secondary polishing processes also uses a high density, formable polishing pads made of a polyurethane or woven material with an amorphous glass material deposited on the polishing surfaces that is derived from metal silicate, and a slurry having particles of a colloidal SiO₂, which are smaller than 1 micron, and make up less than 20% of the slurry by volume. The slurry compositions can vary significantly without effecting the invention and it is understood that these quantities are just one embodiment.

Additionally, a mark can be placed on the ID or OD of the rod which can be used for 1) alignment of the magnetic recording media during servo writing or 2) mounting of the magnetic recording media on the motor in a hard drive. The mark can take the form of a notch or other indicator, which can be detected by the human eye or with a sensor, and should be distinguishable from other features or marks found on the magnetic recording media. The mark can be placed at the ID or OD of the rod in the form of a notch during either the drilling process or the molding process. More specifically, multiple notches can be placed at the ID or OD of the rod, preferably in an orthogonal direction, during the ID drilling process, molding processes or afterwards with the use of a machining tool such as a milling machine. The OD mark can serve the same function as the ID mark.

The mark or notch can be used as an index mark or detectable feature in the servo writing process, which is done external to a hard drive, by assisting with proper placement of a magnetic recording media in a servo track writer. The servo writing process is done during the manufacturing of the data storage device and includes writing or pre-recording servo information on the magnetic recording media, which is used to control head position relative to a magnetic recording media. Servo information can be written onto the magnetic recording media either internally to the hard drive after the hard drive is assembled or externally to the hard drive before the magnetic recording media is assembled in the hard drive. When servo information is written on the magnetic recording media, before it is installed in a hard drive, either a single-disc writers (SDW), which records servo information on one magnetic recording media at a time, or a multi-disc writers (MDW), which records servo information to a plurality of magnetic recording media at a time, can be used. The mark is used to set a reference point in both the SDW and MDW, which can be used again for mounting the magnetic recording media in the hard drive. Additionally, the mark can also be used in an MDW to align the plurality of magnetic recording media so that all of the magnetic recording media are positioned with the marks in a line. Once the reference point is set by the mark the entire stack of magnetic recording media can be balanced in the MDW. Balancing is done by appropriately biasing each magnetic recording media against the hub to balance the entire load so that entire stack is balanced and rotates uniformly for servo writing. This mark can be used as a marker for replacing the laser-index marking (LIM) mark that is currently used in the indexing portion of the MDW process.

The mark or notch can also be used in conjunction with the hard drive spindle motors for centering of the motor with the magnetic recording media. Centering of the motor and magnetic recording media reduces or eliminates run-out from disc-slippage between the magnetic recording media and the motor spindle. The mark is used to center the magnetic recording media on the motor because it serves as reference point for mounting. By knowing the reference point which is the mark and the way the magnetic recording media was biased during the servo writing process, the magnetic recording media can be mounted on the drive so that the rotation center and magnetic center are substantially similar. This helps maintain servo track concentricity after the magnetic recording media are placed in the hard drive.

In step 340 the rod having a center hole is sliced using a cutter. Although this invention is described using a multi-wire cutter to slice the rod having the hole, the slicing can be done with different apparatus' including a laser, high-pressure water cutter, multi-blade saw, or multi-band saw. In one embodiment of the invention a multi-wire cutter is used to cut the rod with a hole in the center. When using a multi-wire cutter, these rods are loaded into a multi-wire cutter like the one shown in FIG. 6. The spacing between the wires is precisely adjusted to match the desired thickness of the substrate slice. The multi-wire cutters can use a slurry, which is fed in front of the wire before it starts the cutting action. The role of slurry is to facilitate the cutting process and making smoother desired substrate surfaces. The choice and chemistry of the slurry is based on the starting material of the rod. The wires can contact the rod surface in a rocking motion with respect to a normal to the center of the rod. This process is helpful for maintaining a uniform load on the entire cutting surface resulting in a much smoother starting surface and thereby either minimizing the final-grind time or completely eliminating the final-grind process discussed in step 360.

Next in step 350 an edge chamfer is created on the ID and OD edges of the substrate slices, if necessary. Step 350 is optional and may only be necessary if the ID and OD dimensions are not the final substrate dimensions. The edge chamfer is created by grinding and polishing the edges of the substrate slice. In step 360 a second polishing and grinding process is performed on the substrate slices to reduce the dimensions and thicknesses to that of finished substrates. The processes of step 360 are similar to the processes of step 330. The times for the first polish process of step 330 and the second polish process of step 360 are important for overall finished substrate cost, and are determined based on the starting material, cutting process, slurry type and the desired thickness. Preferably, the times required for the first polish process of step 330 and the second polish process of step 360 are as low as possible and if possible these steps are entirely removed. Finally the process ends in step 370 where the finished substrates are inspected for quality and before being sent on to be made into magnetic recording media.

FIG. 3B is a flowchart showing another method of making substrates used for magnetic recording media in accordance with another embodiment of the invention. The method of FIG. 3B is similar to the method illustrated in FIG. 3A except that it includes the additional step of surface treatment of the ID and OD of the starting rod in step 380. Surface treatment includes chemical strengthening, thermal tempering, applying a hardening overcoat, adhesive or laminate layer. In step 380, the starting rod having substantially the same ID and OD diameters of the finished substrates can be exposed to the “chemical strengthening process” through ion-exchange prior to the wire cutting. Step 380 is performed before the rods are sliced in step 340 and preferably performed immediately before the rods are sliced in steps 340. The process of chemical strengthening enriches the exposed surfaces with higher amounts of K and/or Li ions creating a compressive stress state on the exposed surfaces of the starting rod. Additionally if this chemically strengthening process is used, it may be desirable to eliminate the steps of polishing and grinding in the subsequent step 360. In still another embodiment the starting rod having an ID and OD diameter substantially similar to the ID and OD of the finished substrate can have its ID and OD flame polished to make both the ID and OD stronger and less prone to cracking.

Although surface treatment is used to make the surfaces of the rods, substrate slices, substrate blanks, and finished substrates stronger and less prone to cracking, the use of smaller finished substrates may reduce the benefits of surface treatment. FIG. 3C is a graph showing Shock vs. Stress by form factor for glass substrates having an OD/ID of 65 mm/20 mm (reference number 390), 1″/7 mm (reference number 392), and 0.85″/6 mm (reference number 394), using an altitude drop tester that drops a substrate from a height of approximately 1.7 meters. The Shock vs. Stress graph shows that the maximum mechanical shock stress (MPa) increases substantially linearly as a function of increasing Mechanical Shock (g—9.8 m/sec²) for the different form factors but the rate of increase is much lower for smaller form factor glass substrates. The results of the data show that small form factors reduce stress at the surface of the substrate near the inside diameter (ID) hole, for a given shock. The data shows on graph 390 that larger glass substrates having an OD/ID of 65 mm/20 mm have a maximum mechanical shock stress of about 20 MPa, for a mechanical shock of 100 g, which increases substantially linearly to a maximum mechanical shock stress of approximately 290 MPa for a mechanical shock of 2000 g. The data also shows on graph 392 that smaller glass substrates having an OD/ID of 1″/7 mm have a maximum mechanical shock stress of about 10 MPa, for a mechanical shock of 100 g, which increases substantially linearly to a maximum mechanical shock stress of approximately 120 MPa for a mechanical shock of 2000 g. Finally, the data shows on graph 394 that even smaller glass substrates having an OD/ID of 0.85″/6 mm have a maximum mechanical shock stress of about 5 MPa, for a mechanical shock of 100 g, which increases substantially linearly to a maximum mechanical shock stress of approximately 55 MPa for a mechanical shock of 2000 g. Since the stress is reduced for small form factors the benefits of surface treatment are reduced making step 380 less beneficial. Therefore, the step 380 becomes even more optional for smaller form factors.

The method of making substrates used for magnetic recording media described above with reference to FIG. 3A and FIG. 3B can be implemented as a computer-readable program storage device which tangibly embodies a program of instructions executable by a computer system to perform a system method. In addition, this method also can be implemented as a method or process itself

FIG. 4 is a bock diagram showing a magnetic recording media 400 using a substrate made with the method described with reference to FIG. 2, FIG. 3A, and FIG. 3B above. The block diagram illustrating the magnetic recording media 400 includes a substrate 410, a first layer 420, a magnetic stack 430, and a protective layer 440. Substrate 410 is made in accordance with the process described above with reference to FIG. 2, FIG. 3A, and FIG. 3B. First layer 420 is used to define the structure of the subsequently deposited layers as well as to set magnetic and electrical properties of the finished magnetic recording media 400. First layer 420, which can include one or more layers, is often referred to as an underlayer or seed layer and can be made of a variety of materials including chromium, titanium, nickel, aluminum, phosphorus, tungsten, alloys containing one or more of these materials, as well as other materials suitable for seed layers or underlayers, depending on the desired final properties. First layer 420 can also further include multiple underlayers or multiple seedlayers, which may or may not be magnetic. Additionally, first layer 420 can also include a soft-magnetic layer if the final media is to be perpendicular media. Magnetic stack 430 refers to the layers in magnetic recording media 400, which give the magnetic recording media 400 its magnetic properties and can include one magnetic, several magnetic layers, several magnetic layers and non-magnetic layers, or combinations of these. The magnetic layers can include magnetic alloys containing cobalt (Co), platinum (Pt) or chromium (Cr), as well as other elements and/or oxides or nitrides of elements such as Si, Ti, Nb, etc. Protective layer 440 can be used to increase durability and to reduce corrosion of the magnetic recording media 400 and can be made of various materials containing carbon, diamond-like-carbon, carbon with hydrogen, carbon with nitrogen, carbon with hydrogen and nitrogen, as well as other materials such as silicon.

FIG. 5 is an exploded perspective view of a magnetic hard drive, which uses a magnetic recording media made using a substrate made in accordance with an embodiment of this invention. The magnetic hard drive 500, illustrated in FIG. 5, includes a housing 505 further having a base 510 sealed to a cover 515 by a seal 520. The hard drive 500 also includes a spindle 530 to which is attached to one or more magnetic recording media 400 having surfaces 540 covered with a magnetic recording media (not shown) for magnetically storing information. Although FIG. 5 illustrates a hard drive 500 using several magnetic recording media 400, only one surface is required to make the hard drive 500 operational. A spindle motor (not shown in this figure) rotates the plurality of magnetic recording media 400 past read/write heads 545 that are suspended above surfaces 540 of the magnetic recording media 400 by a suspension arm assembly 550. Under normal operating conditions, the spindle motor rotates the magnetic recording media 400 at high speeds past the read/write heads 545 while the suspension arm assembly 550 moves and positions the read/write heads over one of several radially spaced tracks (not shown). This allows the read/write heads 545 to read and write magnetically encoded information to the surfaces 540 of the magnetic recording media 400 at selected locations. Although FIG. 5 illustrates a hard drive with a magnetic recording media attached to a spindle motor through a hole in the center of the magnetic recording media an alternative design can include a magnetic recording media without a hole in the center made from a substrate cut from a rod as shown in FIG. 7A. A magnetic recording media not having a hole in its center is attached to the motor and or shaft by the application of an adhesive. Adhesives can include epoxies, or polymers that are curable thermally or with ultraviolet light. Preferably adhesives used will not outgas.

FIG. 6A is an illustration showing a multi-wire cutter used for cutting rods to make substrates for magnetic recording media in accordance with one embodiment of the invention including a table 610, two slurry manifolds 615, a three turn wheels 620, a plurality of wire 625, and five glass rods 630 to be cut into substrate slices. Details of the multi-wire cutter are further discussed below with reference to FIGS. 6B and 6C.

FIG. 6B is a front view of the multi-wire cutter shown in FIG. 6A and used for cutting rods to make substrates for magnetic recording media in accordance with one embodiment of the invention including the table 610, the two slurry manifolds 615, the three turn wheels 620, the plurality of wire 625, the five glass rods 630 to be cut into substrate slices, and two tracks 640. Table 610, which is moveable on tracks 640 in the direction of the arrows shown, is configured to mount several glass rods on the table. The three turn wheels 620 are driven by a motor not shown in this figure which drive a plurality of wires 625 at variable rates of speed. The three turn wheels turn in the direction of the arrows shown on each of the turn wheels. The two slurry manifolds 615 supply slurry material to the wires and the glass rod to facilitate cutting of the rods and to improve the quality of the cutting. As table 610 moves upward, the glass rods on the table are sliced with the plurality of wires 625 as shown. Alternatively the plurality of wires along with the three turn wheels can move in the opposite direction while the table and rods remain stationary. As long as there is relative motion between the rods and the wires in the direction of the arrows shown, the rods will be sliced into substrate slices. Additionally, table 610 can be rocked back and forth so that the rods are rocked back and forth to assist in the cutting of the rods. The range and period of the rocking motion can vary depending the thickness of the rod and the material of the rod. For example the rocking range can be between 0 and 5 degrees and preferably about 2 degrees while the period of the rocking motion can be several minutes. Alternatively, the table and rods can remain stationary and the wires can be rocked back and forth.

FIG. 6C is a bottom view of the multi-wire cutter shown in FIG. 6A and used for cutting rods to make substrates for magnetic recording media in accordance with one embodiment of the invention including the table 610, two slurry manifolds 615, two of three turn wheels 620, the plurality of wire 625, a motor 650, and a shaft 655. Table 610 supports the rods as wires 625, which are moved by the three turn wheels 620, are slicing them. The motor 650 rotate the turn wheels 620, which is attached to one of the turn wheels 620 through shaft 655. The plurality of wires 625 move over the top of the turn wheels but under the slurry manifolds 615 which deposit slurry material onto the wires to assist with cutting the rods.

FIG. 7A-7D are illustrations of various rods that can be used to make substrates in accordance with different embodiments of this invention. FIG. 7A is an illustration showing a simple first rod 710 used to make substrates for magnetic recording media in accordance with one embodiment of the invention. The first rod 710 shown in FIG. 7A has an outside diameter that is substantially close in diameter to the outside diameter of a finished substrate but does not have a hole in the center so if a finished substrate with a center hole is the final design then the rod must either first have the hole drilled out before it is sliced into substrate slices or the holes will be drilled out of the individual substrate slices once the rod is sliced into substrate slices. Preferably, the first rod 710 has an outside diameter that is identical to the outside diameter of a finished substrate so that the step of grinding the outside diameter to the finished dimension can be eliminated. The outside diameter of the first rod 710 is 75 mm or less, and preferably between 15 mm to 75 mm depending on the desired final dimensions of the substrate. Although there are no restrictions on the length of first rod 710 other than the length be manageable, a preferable length is 5 to 25 cm, because this is an easy length to handle. Table 2 contains some examples of rod dimensions.

TABLE 2
Examples of Rod Dimensions shown in FIG. 7A

| Outside Diameter | Length |
|---|---|
| 65.0 ± 1.0 mm | 5-25 cm |
| 48.0 ± 1.0 mm | 5-25 cm |
| 27.4 ± 1.0 mm | 5-25 cm |
| 21.6 ± 1.0 mm | 5-25 cm |

FIG. 7B is an illustration showing a second rod 720 with a hole drilled in the center used to make substrates for magnetic recording media in accordance with another embodiment of the invention. The second rod 720 shown in FIG. 7B includes a hole drilled through the center, which is close in size to the inside diameter of the finished substrate. Preferably the second rod 720 has an inside diameter that is identical to the inside diameter of the finished media. Alternatively the inside diameter can be slightly smaller than the inside diameter of the finished media so that the inside diameter can be ground to the final dimensions of a finished media after the substrate is cut. If a subsequent grinding step is used to increase the inside diameter of the cut substrate, then the inside diameter of second rod 720 should be chosen so that the final grinding step is minimized. Like first rod 710, second rod 720 can have an outside diameter that is identical to the outside diameter of a finished substrate so that the step of grinding the outside diameter to the finished dimension can be eliminated. Alternatively, the outside diameter of second rod 720 can be made larger than the outside diameter of the finished media so that the outside diameter can be ground to the final dimensions of a finished media after the substrate is cut. If a subsequent grinding step is used to decrease the outside diameter of the cut substrate, then the outside diameter of second rod 720 should be chosen so that the final grinding step is minimized. The outside diameter of the second rod 720 can range from 15 mm to 75 mm depending on the desired final dimensions of the substrate. Similarly, the inside diameter of the second rod 720 can range from 7 mm to 25 mm, also depending on the desired final dimensions of the substrate. Although there are no restrictions on the length of second rod 720 other than the length be manageable, a preferable length is 5 to 25 cm, because this is an easy length to handle. Table 3 contains some examples of rod dimensions.

TABLE 3
Examples of Rod Dimensions shown in FIG. 7B

| Outside Diameter | Inside Diameter | Length |
|---|---|---|
| 65.0 ± 1.0 mm | 25.0 ± 1.0 mm | 5-25 cm |
| 65.0 ± 1.0 mm | 20.0 ± 1.0 mm | 5-25 cm |
| 48.0 ± 1.0 mm | 20.0 ± 1.0 mm | 5-25 cm |
| 27.4 ± 1.0 mm | 7.0 ± 1.0 mm | 5-25 cm |
| 21.6 ± 1.0 mm | 7.0 ± 1.0 mm | 5-25 cm |

Additionally, the ID of first rod 710 as well as the ID and OD of second rod 720 can be subjected to a surface treatment as described above with reference to FIG. 3B. The surface treatment process makes the surfaces of the rods stronger and less prone to cracking. In another embodiment first rod 710 having an ID similar to the ID of a finished substrate and second rod 720 having an ID and OD diameter substantially similar to the ID and OD of the finished substrate can have their ID and OD flame polished to make both the ID and OD also stronger and less prone to cracking.

FIG. 7C is an illustration showing third rod 730, which is equivalent to second rod 720 with v-shaped grooves 735 used to make substrates having an edge chamfer for magnetic recording media in accordance with another embodiment of the invention. The groove dimensions are selected based on the final dimensions of the edge chamfer of the finished substrate. The grooved dimensions comprise the angles, arc-lengths, slopes, lengths, spacing, etc. For example an angle of 20-70 degrees referenced from the outside surface of the rod. Similarly FIG. 7D is an illustration showing fourth rod 740, which is equivalent to second rod 720 with long half hexagon grooves 745 used to make substrates having an edge chamfer for magnetic recording media in accordance with one embodiment of the invention. The dimensions are chosen as described above with referenced to FIG. 7C. Additionally, when cutting the rod with the grooves the cutter elements are aligned with the grooves on the outside surface of the rod so that the cutting is done through the center of the grooves.

First rod 710, second rod 720, third rod 730, and fourth rod 740 shown in FIGS. 7A-7D, respectfully can be made of any material which will eventually be used to make a substrate. For example the material can be glass, ceramic, silicon, sapphire, plastic, or metal. More specifically if the substrate is used for glass media used in hard drives the rods can be made of chemically treated glass, glass, boro-silicate glass, glass that is substantially free of alkali compounds such as oxides and salts of sodium and potassium, or chemically treatable glass. Additionally, the starting rods can be noncircular such as square, hexagonal, elliptical, polygon or any other shape provided that the dimensions will support a final desired outside diameter for the finished substrate.

It will also be recognized by those skilled in the art that, while the invention has been described above in terms of preferred embodiments, it is not limited thereto. Various features and aspects of the above-described invention may be used individually or jointly. Further, although the invention has been described in the context of its implementation in a particular environment and for particular applications, those skilled in the art will recognize that its usefulness is not limited thereto and that the present invention can be utilized in any number of environments and implementations.

We claim:

1. A method for making substrates used for magnetic recording media, comprising:
providing a rod made out of a substrate material; and
cutting said rod with a cutter having cutting elements to make a substrate slice, said cutting elements positioned to substantially match the desired thickness of a substrate blank.

2. The method of claim 1 wherein said cutter is a multi-wire cutter and said cutting elements are wires.

3. The method of claim 1 wherein said cutter is selected from the group consisting of multi-wire cutter, laser, high pressure impingement cutter, high pressure water jet cutter, multi-band saw, and multi-blade saw.

4. The method of claim 1 wherein said rod has an outside diameter substantially similar to the outside diameter of a finished substrate.

5. The method of claim 2 wherein said cutting process further uses a slurry to facilitate cutting and the wires of said multi-wire cutter contact the rod in rocking motion.

6. The method of claim 1 wherein said rod has a hole in the center with an inner diameter.

7. The method of claim 6 wherein said hole creates a rod having an inside diameter that is substantially close to an inner diameter of said substrate.

8. The method of claim 6 further comprising marking said inner diameter with a mark.

9. The method of claim 8 wherein said mark is used for indexing a magnetic recording media made with said substrate when said magnetic recording media is servo written.

10. The method of claim 1 further including the step of drilling a hole substantially in the center of the rod, wherein said hole has a diameter that is substantially similar to an inner diameter of said substrate.

11. The method of claim 1 wherein said substrate material is glass.

12. The method of claim 1 wherein said substrate material is glass that has been surface treated.

13. The method of claim 1 wherein the substrate material is glass that is substantially free of alkali compounds.

14. The method of claim 1 wherein said substrate material is selected from the group consisting of glass, ceramic, silicon, sapphire, plastic, and metal.

15. The method of claim 1 wherein the outside diameter of the rod is 75 mm or less.

16. The method of claim 1 further comprising making grooves on the outside surface of the rod.

17. The method of claim 1 further comprising making grooves on the outside surface of the rod that are spaced according to said cutting elements of said cutter.

18. The method of claim 16 wherein said step of cutting said rod with a cutter further comprises cutting said rod by aligning said cutting elements of the cutter with the grooves on the outside surface of the rod so that the cutting is done substantially in the center of the groove.

19. The method of claim 16 wherein said grooves are a shape selected from the group consisting of v-shape and long half hexagon.

20. A method for making substrates, comprising:
providing a rod made out of a substrate material, wherein said rod has an outside diameter substantially the same size as the outside diameter of said finished substrate; and
cutting said rod with a multi-wire cutter to make a substrate slice substantially the same size as a finished substrate, wherein said mutli-wire cutter has wires positioned to substantially match the desired thickness, and wherein said cutting process uses a slurry to facilitate cutting and the wires of said multi-wire cutter contact the rod in rocking motion.

21. The method of claim 20 wherein said rod further comprises an inside diameter substantially the same size as the inside diameter of the finished substrate.

22. The method of claim 21 further comprising the step of polishing the surface of the substrate slice so that the thickness of the substrate slice is substantially the same as the thickness of the finished substrate.

23. The method of claim 21 further comprising the step of grinding the inside diameter and outside diameter edges of the substrate slice to obtain dimension closer to the finished substrates.

24. The method of claim 21 further comprising the step of creating an edge chamfer.

25. The method of claim 21 further comprising a step of making grooves on an outside surface of the rod.

26. A method for making substrates, comprising:
providing a rod made out of a substrate material, wherein said rod has an outside diameter substantially the same size as the outside diameter of the finished substrate;
drilling a hole substantially in the center of the rod, wherein said hole has a diameter that is substantially similar to an inner diameter of the finished substrate;
cutting said rod with a multi-wire cutter to make a substrate slice substantially the same size as the finished substrate, wherein said mutli-wire cutter has wires positioned to substantially match the desired thickness , and wherein said cutting process uses a slurry to facilitate cutting and the wires of said multi-wire cutter contact the rod in rocking motion;
grinding the inside diameter and outside diameter edges of said substrate slice to obtain a substrate blank having dimensions closer to the finished substrates;
polishing the inside diameter and outside diameter edges of said substrate blank to obtain dimension of the finished substrates.

27. The method of claim 26 further comprising marking the inner diameter with a mark.

28. The method of claim 26 further comprising making grooves on an outside surface of the rod.

29. A method for making substrates, comprising:
providing a rod made out of a substrate material, wherein said rod has an outside diameter substantially the same size as the outside diameter of the finished substrate;
making grooves on an outside surface of the rod;
drilling a hole in the center of the rod, wherein said hole has a diameter that is substantially similar to an inner diameter of a finished substrate;
surface treating the inside and outside surface of the rod;
cutting said rod with a multi-wire cutter to make a substrate slice substantially the same size as the finished substrate, wherein said mutli-wire cutter has wires positioned to substantially match the desired thickness , and wherein said cutting process uses a slurry to facilitate cutting and the wires of said multi-wire cutter contact the rod in rocking motion;
grinding the inside diameter and outside diameter edges of said substrate slice to obtain a substrate blank having dimensions closer to the finished substrates;
polishing the inside diameter and outside diameter edges of said substrate blank to obtain dimension of the finished substrates.

30. The method of claim 29 further comprising marking the inner diameter with a mark.

31. The method of claim 29 wherein said grooves are the shape of a long half hexagon.

32. A magnetic recording media, comprising:
a substrate made by cutting a rod having an outside diameter and inside diameter with a multi-wire cutter to make a substrate slice substantially the same size as a finished substrate;
a first layer acting as an underlayer deposited on said substrate;
a magnetic stack deposited over said first layer for providing magnetic properties used to record information; and
a protective overcoat deposited over said magnetic stack for protecting said magnetic layer.

33. The magnetic recording media of claim 32 wherein said outside diameter is substantially the same as the outside diameter of said magnetic recording media and said inside diameter is substantially the same size as the inside diameter of said magnetic recording media.

34. The magnetic recording media of claim 32 wherein said mutli-wire cutter has wires positioned to substantially match the desired thickness of the substrate, and wherein said cutting process uses a slurry to facilitate cutting and the wires of said multi-wire cutter contact the rod in rocking motion.

35. A data storage devise, comprising:
a housing;
a magnetic recording media further comprising:
a substrate made by cutting a glass rod having an outside diameter and inside diameter with a multi-wire cutter to make a substrate slice substantially the same size as a finished substrate;
a first layer acting as an underlayer deposited on said substrate;
a magnetic stack deposited over said first layer for providing magnetic properties used to record information;
a protective overcoat deposited over said magnetic stack for protecting said magnetic layer;
a head capable of recording and retrieving information from said magnetic recording media; and
a motor for rotating said magnetic recording media so that said head is capable of accessing portions of said magnetic recording media.
